(19) United States
(12) Patent Application Publication
(10) Pub. No.: US 2022/0219673 A1
(43) Pub. Date: Jul. 14, 2022

(54) CONTROL SYSTEM FOR HYBRID VEHICLE

(71) Applicant: TOYOTA JIDOSHA KABUSHIKI KAISHA, Toyota-shi Aichi-ken (JP)

(72) Inventors: Hiroshi Watanabe, Mishima-shi Shizuoka-ken (JP); Kohji Yamamoto, Okazaki-shi Aichi-ken (JP); Ryutaro Moriguchi, Gotemba-shi Shizuoka-ken (JP); Takashi Matsumoto, Gotemba-shi Shizuoka-ken (JP); Takeru Tomita, Susono-shi Shizuoka-ken (JP); Yuma Matsumoto, Susono-shi Shizuoka-ken (JP); Kentaroh Kanzaki, Toyota-shi Aichi-ken (JP); Takayoshi Kawai, Susono-shi Shizuoka-ken (JP)

(21) Appl. No.: 17/571,872

(22) Filed: Jan. 10, 2022

(30) Foreign Application Priority Data
Jan. 13, 2021 (JP) 2021-003459

(51) Int. Cl. B60W 20/13; B60W 10/06; B60W 10/08; B60W 10/26; B60W 20/20; B60K 6/442

(52) U.S. Cl. CPC B60W 20/13; B60W 10/06; B60W 10/08; B60W 10/26; B60W 2520/10; B60K 6/442; B60W 2510/244; B60W 2710/083; B60W 20/20

(57) ABSTRACT

A control system for a hybrid vehicle that is configured to generate a driving force as required even if it is necessary to charge a battery rapidly. The hybrid vehicle may be propelled in a parallel mode in which power of the engine is partially translated into electric power by a motor and the remaining power of the engine is delivered to drive wheels. In a case that a rapid charging command is transmitted and that a required driving force is greater than a first driving force, the motor is operated to generate electric power in a predetermined amount, and the driving force is restricted to the first driving force.

### CROSS-REFERENCE TO RELATED APPLICATIONS

The present disclosure claims the benefit of Japanese Patent Application No. 2021-003459 filed on Jan. 13, 2021 with the Japanese Patent Office.

### BACKGROUND

### Technical Field

Embodiments of the present disclosure relate to the art of a control system for a hybrid vehicle in which a prime mover includes an engine and a motor, and in which a torque of the motor can be synthesized with a torque of the engine being delivered to drive wheels.

### Discussion of the Related Art

WO 2019/116586 A1 describes a device for controlling a hybrid vehicle configured to convert a power of an engine into an electric power by an electric generator, and to supply the electric power to a drive motor and a battery. According to the teachings of WO 2019/116586 A1, a running mode of the hybrid vehicle can be selected from a normal mode, a silent mode, and a charge mode by operating a running-mode selection switch. Specifically, in the normal mode, the battery is charged by the electric generator in such a manner that a state of charge level fall within a range between a normal lower limit level and a normal upper limit level. By contrast, in the charge mode, the battery is charged by the electric generator in such a manner that a state of charge level fall within a range between another lower limit level which is higher than the normal lower limit level and another upper limit level which is lower than the normal upper limit level. That is, in the charge mode, the state of charge level of the battery is maintained to the higher level compared to the normal mode.

JP-A-2020-163914 describes a hybrid vehicle comprising an engine, a generator that translates power of the engine into an electric power, and a motor connected to a torque transmission route between the engine and drive wheels. The hybrid vehicle taught by JP-A-2020-163914 can be propelled in a parallel mode in which torques of the engine and the motor are delivered to the drive wheel, and the power of the engine is partially translated into an electric power by the generator. According to the teachings of JP-A-2020-163914, the hybrid vehicle is provided with an operation device which is operated by a user to change an amount of the power translated into electric power by the generator on the basis of an operation state of the operation device.

According to teachings of WO 2019/116586 A1, a drive torque is generated only by the motor, and a generation amount of the generator may be changed arbitrarily. Accordingly, a maximum driving force to propel the hybrid vehicle is governed only by a capacity of the motor, and is not changed depending on an operating condition of the engine. That is, the maximum driving force to propel the hybrid vehicle will not be changed even if the running mode is shifted between the normal mode and the charge mode. In the hybrid vehicle described in WO 2019/116586 A1, therefore, a required driving force may always be achieved during propulsion in the charge mode based on a state of charge level of the battery.

However, in the so-called “parallel hybrid vehicle” in which a motor is disposed on a torque transmission route between an engine and drive wheels, a maximum driving force of a case in which the motor is operated as a generator would be reduced less than a maximum driving force of a case in which the motor is operated as a motor. In the parallel hybrid vehicle, therefore, an actual driving force would be deviated significantly from a required driving force if a generation amount is determined based on a state of charge level of the battery during propulsion in the charge mode as described in WO 2019/116586 A1.

On the other hand, according to the teachings of JP-A-2020-163914, a generation amount is changeable in the parallel mode. However, in the hybrid vehicle described in JP-A-2020-163914, the maximum driving force will be reduced with an increase in the generation amount. In the hybrid vehicle described in JP-A-2020-163914, therefore, an actual driving force would be deviated significantly from a required driving force if an amount of the power translated into electric power by the generator is determined on the basis of an operation state of the operation device.

### SUMMARY

Aspects of embodiments of the present disclosure have been conceived noting the foregoing technical problems, and it is therefore an object of the present disclosure to provide a control system for a hybrid vehicle in which a power of an engine can be utilized not only for propulsion but also for electric power generation, that is configured to generate a driving force without reducing significantly even if it is necessary to charge a battery rapidly.

The control system according to the exemplary embodiment of the present disclosure is applied to a hybrid vehicle comprising: an engine; and a motor that translates a power delivered thereto from the engine partially into an electric power by generating a regenerative torque, and that applies a drive torque to a pair of drive wheels. The hybrid vehicle may be propelled in a parallel mode in which the power generated by the engine is partially translated into the electric power by the motor and the remaining power generated by the engine is delivered to the drive wheels, or the power generated by the engine and a power generated by the motor are delivered to the drive wheels. In the hybrid vehicle, a driver is allowed to manually transmit a charging command to increase a power generation amount of the motor to a predetermined generation amount during propulsion in the parallel mode. In order to achieve the above-explained objective, according to the exemplary embodiment of the present disclosure, the control system is provided with a controller that controls torques of the engine and the motor. The controller comprises a charge determiner that determines a transmission of the charging command, and a driving force detector that calculates a required driving force to propel the hybrid vehicle. Specifically, the controller is configured to operate the motor to generate the electric power in the predetermined generation amount while restricting a driving force to a first driving force, in a case that the charge determiner determines the transmission of the charging command and that the required driving force calculated by the driving force detector is greater than the first driving force.

In a non-limiting embodiment, the controller may be further configured to operate the motor to generate the electric power in the predetermined generation amount while generating the driving force in line with the required driving force, in a case that the charge determiner determines the transmission of the charging command and that the required driving force calculated by the driving force detector is equal to or less than the first driving force.

In a non-limiting embodiment, the controller may be further configured to restrict the power generation amount of the motor to the predetermined generation amount or less while generating the driving force in line with the required driving force, in a case that the charge determiner determines the transmission of the charging command, that the required driving force calculated by the driving force detector is equal to or less than the first driving force, and that the required driving force is increased greater than the first driving force.

In a non-limiting embodiment, the first driving force may be set to a value to be achieved by generating a maximum torque of the engine while generating the electric power in the predetermined generation amount.

In a non-limiting embodiment, the controller may be further configured to restrict the power generation amount of the motor to the predetermined generation amount or less while generating the driving force in line with the required driving force, in a case that the charge determiner determines the transmission of the charging command, and that the required driving force calculated by the driving force detector is greater than a second driving force that is greater than the first driving force.

In a non-limiting embodiment, the second driving force may be set to a value to be achieved by generating a maximum torque of the engine while stopping the motor.

In a non-limiting embodiment, the controller may be further configured to operate the motor to generate the electric power in the predetermined generation amount while restricting the driving force to the first driving force, in a case that the charge determiner determines the transmission of the charging command, that the required driving force calculated by the driving force detector is greater than the second driving force, and that a current available driving force to propel the hybrid vehicle is restricted to the second driving force.

In a non-limiting embodiment, the control system may further comprise an electric storage device that is electrically connected with the motor. In addition, the controller may be further configured to restrict the current available driving force to propel the hybrid vehicle to the second driving force in a case that a state of charge level of the electric storage device is equal to or lower than a predetermined level, or that a speed of the hybrid vehicle is equal to or higher than a predetermined level.

Thus, the control system according to the exemplary embodiment of the present disclosure is applied to the hybrid vehicle comprising the motor that translates a power delivered thereto from the engine partially into an electric power by generating a regenerative torque. As described, in the hybrid vehicle, the driver is allowed to manually transmit the charging command to increase a power generation amount of the motor to a predetermined generation amount during propulsion in the parallel mode. As a result of increasing the power generation of the motor to the predetermined generation amount, the output power of the engine delivered to the drive wheels would be reduced. That is, the available driving force to propel the hybrid vehicle would be reduced. In order not to reduce the driving force significantly in the above-explained situation, according to the exemplary embodiment of the present disclosure, the motor generates the electric power in the predetermined generation amount while restricting the driving force to the first driving force, in the case that the charging command is transmitted by the driver, and that the required driving force is greater than the first driving force. According to the exemplary embodiment of the present disclosure, therefore, a required power generation amount may be achieved by the motor without reducing the driving force significantly from the required driving force.

### BRIEF DESCRIPTION OF THE DRAWINGS

Features, aspects, and advantages of exemplary embodiments of the present disclosure will become better understood with reference to the following description and accompanying drawings, which should not limit the disclosure in any way.

FIG. 1 is a schematic illustration showing a structure of a hybrid vehicle to which the control system according to the exemplary embodiment of the present disclosure is applied;

FIG. 2 is a map determining a required driving force with respect to a position of the accelerator pedal;

FIG. 3 is a block diagram showing a structure of an electric control unit;

FIG. 4 is a flowchart showing a routine to determine a priority of a generation of driving force and electric power in accordance with a required driving force when a charging switch is turned on;

FIG. 5 is a flowchart showing a routine to be executed when the required driving force is equal to or less than the first driving force during propulsion in a rapid charging mode;

FIG. 6 is a flowchart showing a routine to be executed when the required driving force is greater than the first driving force but equal to or less than a second driving force during propulsion in the rapid charging mode;

FIG. 7 is a flowchart showing a routine to be executed when the required driving force is greater than the second driving force but an available driving force is equal to or less than the second driving force during propulsion in the rapid charging mode; and

FIG. 8 is a flowchart showing a routine for integrally executing the routines shown in FIGS. 4 to 7.

### DETAILED DESCRIPTION OF THE EMBODIMENT(S)

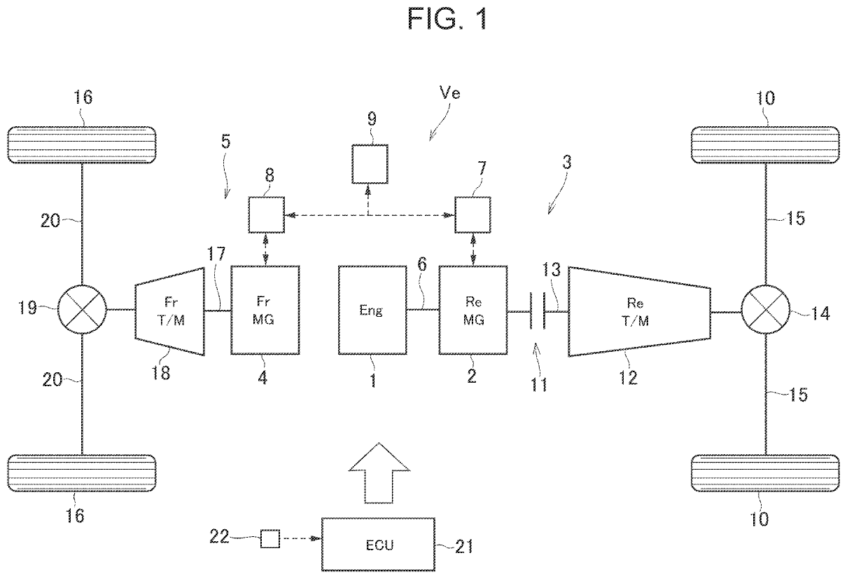

An exemplary embodiment of the present disclosure will now be explained with reference to the accompanying drawings. Referring now to FIG. 1, there is shown one example of a structure of a vehicle Ve to which the control system according to the embodiment of the present disclosure is applied. The vehicle Ve shown in FIG. 1 is a four-wheel drive layout hybrid vehicle in which a prime mover comprises: a rear drive unit 3 including an engine (referred to as “Eng” in FIG. 1) 1, and a rear motor (referred to as “Re-MG” in FIG. 1) 2; and a front drive unit 5 including a front motor (referred to as “Fr-MG” in FIG. 1) 4.

For example, a gasoline engine and a diesel engine may be adopted as the engine 1, and an output torque of the engine 1 is changed by controlling an intake air, a fuel injection, and an ignition timing. When the engine 1 is rotated passively while stopping a fuel supply thereto, a brake force derived from a friction torque and a pumping loss is applied to an output shaft 6 of the engine 1. That is, a fuel-cut control may be executed. In the following explanations, the torque generated by the engine 1 will also be referred to as the engine torque.

For example, an AC motor such as a synchronous motor in which a rotor is provided with a permanent magnet may be adopted as the rear motor 2 and the front motor 4, respectively. That is, each of the rear motor 2 and the front motor 4 may serve not only as a motor to generate a torque to increase a rotational speed of an output shaft thereof, but also as a generator to partially translate a power of the output shaft thereof into an electric power by generating a torque in a direction to reduce a speed of the output shaft.

The rear motor 2 is connected to an inverter 7 and the front motor 4 is connected to an inverter 8, and the inverters 7 and 8 are connected to an electric storage device 9 as a battery, respectively. Each of the inverters 7 and 8 is provided individually with a switch element in which a diode and a transistor are connected in parallel. That is, a current value and a frequency of the current supplied to the rear motor 2 is controlled by the inverter 7 in accordance with an incident signal to the switch element of the inverter 7, and a current value and a frequency of the current supplied to the front motor 4 is controlled by the inverter 8 in accordance with an incident signal to the switch element of the inverter 8. In addition, the inverter 7 and the inverter 8 are connected to each other so that electric power may be exchanged between the inverter 7 and the inverter 8.

The torque distributed to a pair of rear wheels 10 is controlled by the rear drive unit 3, and in the example shown in FIG. 1, the rear motor 2 serving as a motor of the embodiment is disposed on a torque transmitting route between the engine 1 and the rear wheels 10. Specifically, in the rear drive unit 3, a rotor of the rear motor 2 is fitted onto the output shaft 6 of the engine 1 through e.g., a spline so that a torque of the rear motor 2 is applied to the output shaft 6. That is, when generating a regenerative torque by the rear motor 2, a power generated by the engine 1 may be partially translated into an electric power depending on a magnitude of the regenerative torque. Whereas, when generating a drive torque by the rear motor 2, powers of the engine 1 and the rear motor 2 may be delivered to the rear wheels 10. Instead, the rear motor 2 may also be connected to the output shaft 6 of the engine 1 through a gear pair, a torque converter, a clutch device or the like.

The output shaft 6 of the engine 1 further extends from the rear motor 2 toward a rear section of the vehicle Ve, and a leading end of the output shaft 6 is connected to a clutch device 11. For example, a dog clutch and a friction clutch may be adopted as the clutch device 11, and a torque transmission between the rear motor 2 and a rear transmission (referred to as “Re T/M” in FIG. 1) 12 is interrupted by disengaging the clutch device 11. That is, a torque transmission between the engine 1 and the rear wheel 10 is interrupted by disengaging the clutch device 11.

Specifically, the rear transmission 12 is connected to an output shaft 13 of the clutch device 11 so that rotational speeds of the engine 1 and the rear motor 2 are changed by the rear transmission 12. For example, a geared transmission having a plurality of engagement devices and a continuously variable transmission may be adopted as the rear transmission 12. In a case of employing the geared transmission as the rear transmission 12, a gear stage of the rear transmission 12 is shifted among a plurality of stages by manipulating the engagement devices. By contrast, in a case of using the continuously variable transmission as the rear transmission 12, a speed ratio of the rear transmission 12 may be varied continuously. The rear transmission 12 is connected to the rear wheels 10 through a rear differential gear unit 14 and rear driveshafts 15.

The output torque of the engine 1 (i.e., the engine torque) and the output torque of the rear motor 2 (hereinafter also referred to as the motor torque) are delivered to the rear transmission 12, and further delivered to the rear wheels 10 while being changed in accordance with a speed ratio set by the rear transmission 12. In the rear drive unit 3, therefore, the torque delivered to the rear transmission 12 and the rear wheels 10 may be changed by changing any one of the engine torque and the motor torque.

The engine torque is controlled based on an engine speed in such a manner as to adjust an operating point of the engine 1 to a most fuel efficient point. On the other hand, the motor torque may be set to a torque corresponding to a difference between a target input torque to the rear transmission 12 and the engine torque. Specifically, the target input torque to the rear transmission 12 may be calculated based on a required driving force F_{req} to propel the vehicle Ve and a speed ratio of the rear transmission 12. That is, if the target input torque to the rear transmission 12 is greater than the engine torque, the rear motor 2 generates a torque to achieve the target input torque. By contrast, if the target input torque to the rear transmission 12 is less than the engine torque, the rear motor 2 generates a brake torque to cancel an excess torque.

On the other hand, the torque distributed to a pair of front wheels 16 is controlled by the front drive unit 5. In the front drive unit 5, an output shaft 17 of the front motor 4 is connected to a front transmission (referred to as “Fr T/M” in FIG. 1) 18. For example, a geared transmission and a continuously variable transmission may also be adopted as the front transmission 18. The front transmission 18 is connected to the front wheels 16 through a front differential gear unit 19 and front driveshafts 20. As an option, the front transmission 18 may be provided with an additional clutch device to interrupt torque transmission between the front motor 4 and the front wheels 16 when coasting or when driving only the rear wheel 10.

The engine 1, the rear motor 2, the front motor 4, the inverter 7, the inverter 8, the rear transmission 12, the front transmission 18, the clutch device 11 and so on are controlled by an electronic control unit (to be abbreviated as the “ECU” hereinafter) 21 as a controller. The ECU 21 comprises a microcomputer as its main constituent that is configured to preform calculation based on incident data transmitted from sensors arranged in the vehicle Ve, and formulas, maps control flows etc. installed in advance. Calculation results are transmitted from the ECU 21 to the devices controlled by the ECU 21 in the form of command signal.

For example, the ECU 21 receives data about: a speed of the vehicle Ve detected by a vehicle speed sensor; a speed of the engine 1 detected by an engine speed sensor; a speed of the rear motor 2 detected by a motor speed sensor; a speed of the front motor 4 detected by another motor speed sensor; a position of an accelerator pedal (not shown) detected by an accelerator sensor; a state of charge (to be abbreviated as “SOC” hereinafter) level of the electric storage device 9 detected by a battery sensor (neither of the sensors are shown); and a rapid charging command transmitted from an after-mentioned charging switch 22 that is operated manually by a driver.

The maps installed in the ECU 21 include: a map determining a required driving force F_{req} to propel the vehicle Ve based on a position of the accelerator pedal and a speed of the vehicle Ve; and maps determining speed ratios of the rear transmission 12 and the front transmission 18 based on a position of the accelerator pedal and a required driving force F_{req}.

The vehicle Ve may be propelled in a parallel mode in which the vehicle Ve is propelled by delivering the engine torque to the rear wheels 10. In the parallel mode, specifically, the motor torque (i.e., a drive torque) is added to the engine torque, or a power generated by the engine 1 is translated into an electric power by the rear motor 2 at least partially. In addition, in the parallel mode, it is also possible to deliver the torque generated by the front motor 4 to the front wheels 16. Thus, in the parallel mode, the vehicle Ve is propelled by driving the rear wheels 10 by the torques of the engine 1 and the rear motor 2.

The vehicle Ve may also be propelled in a series mode in which the vehicle Ve is powered only by the front motor 4. In the series mode, specifically, the clutch device 11 is disengaged, and the power of the engine 1 is translated into an electric power by the rear motor 2. The power thus translated by the rear motor 2 and the electric power accumulated in the electric storage device 9 are supplied to the front motor 4 propel the vehicle Ve. The operating mode of the vehicle Ve may be shifted from the series mode to an electric vehicle mode (to be abbreviated as the “EV mode” hereinafter) by stopping the engine 1. In the EV mode, the front motor 4 is operated to propel the vehicle Ve only by the electric power supplied from the electric storage device 9.

During propulsion in the parallel mode or the series mode, an excess power may be translated into an electric power to charge the electric storage device 9 by generating a greater power than a required power by the engine 1. In other words, the electric storage device 9 can be charged by generating a power for charging the electric storage device 9 by the engine 1, in addition to a required power to propel the vehicle Ve.

According to the exemplary embodiment of the present disclosure, a charging mode of the electric storage device 9 may be selected from a normal charging mode and a rapid charging mode. In order to shift the charging mode between the normal charging mode and the rapid charging mode, the vehicle Ve is provided with the charging switch 22 that is operated by a driver or passenger. Specifically, when the charging switch 22 is turned on, the charging mode is shifted to the rapid charging mode and an amount of power generation by the rear motor 2 is increased compared to that in the normal charging mode. That is, the charging switch 22 is an operating device such as a button and a lever, and the charging switch 22 may be arranged in an instrumental panel, a steering wheel and so on. For example, the charging switch 22 may be adapted to continuously transmit the rapid charging command (or a switch-on signal) as long as being operated. Instead, the charging switch 22 may also be adapted to transmit the rapid charging command when it is turned on, and to stop transmission of the rapid charging command when it is turned off.

When the rapid charging mode is selected by operating the charging switch 22, the rear motor 2 is operated in such a manner as to generate an electric power in a maximum amount corresponding to a “predetermined generation amount” of the embodiment. Here, it is to be noted that the maximum electric power possible to be generated by the rear motor 2 changes depending on an operating condition of the rear motor 2 such as a temperature and an operating point of the rear motor 2, a temperature of the inverter 7, a temperature and a state of charge level of the electric storage device 9 and so on. In addition, in order to prevent an abrupt slowdown of the vehicle Ve when the output torque of the engine 1 is reduced abruptly for some reason, the maximum electric power to be generated by the rear motor 2 is limited in such a manner that a regenerative torque of the rear motor 2 is limited less than a predetermined upper limit torque.

Thus, in the case that the rapid charging mode is selected during propulsion in the parallel mode or the series mode, the engine 1 is requested to generate a power required to drive the rear wheel 10, and a power comparable to a maximum electric power possible to be translated by the rear motor 2.

During propulsion in the parallel mode, the driving force generated by the rear wheels 10 may be increased to a maximum value by adding the motor torque to the engine torque, and the driving force to propel the vehicle Ve may be increased to a maximum value by generating a drive torque by the front motor 4.

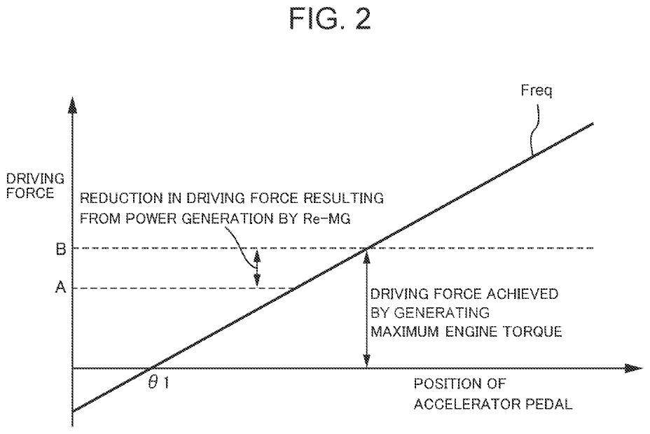

Turning to FIG. 2, there is shown a map determining a required driving force with respect to a position of the accelerator pedal, in which the vertical axis represents a driving force to propel the vehicle Ve, and the horizontal axis represents a position of the accelerator pedal. As indicated in FIG. 2, according to the exemplary embodiment of the present disclosure, the required driving force is increased in proportion to an increase in depression of the accelerator pedal. When it is necessary to charge the electric storage device 9, the rear motor 2 is operated as a generator, and hence the output torque of the engine 1 delivered to the rear wheels 10 is reduced. In this case, therefore, the driving force to be generated by the rear wheels 10 would be reduced compared to that of the case in which the rear motor 2 is operated as a motor. In addition, power distribution to the front motor 4 is stopped. As a result, the driving force to propel the vehicle Ve would be reduced from a second driving force B to be achieved by generating the maximum torque of the engine 1. That is, when the rapid charging mode is selected by operating the charging switch 22, the maximum driving force to people the vehicle Ve would be reduced.

According to the exemplary embodiment of the present disclosure, therefore, the control system is configured to determine whether to generate a required electric power by the motor in the rapid charging mode, and to determine whether to generate a required driving force F_{req} in the rapid charging mode.

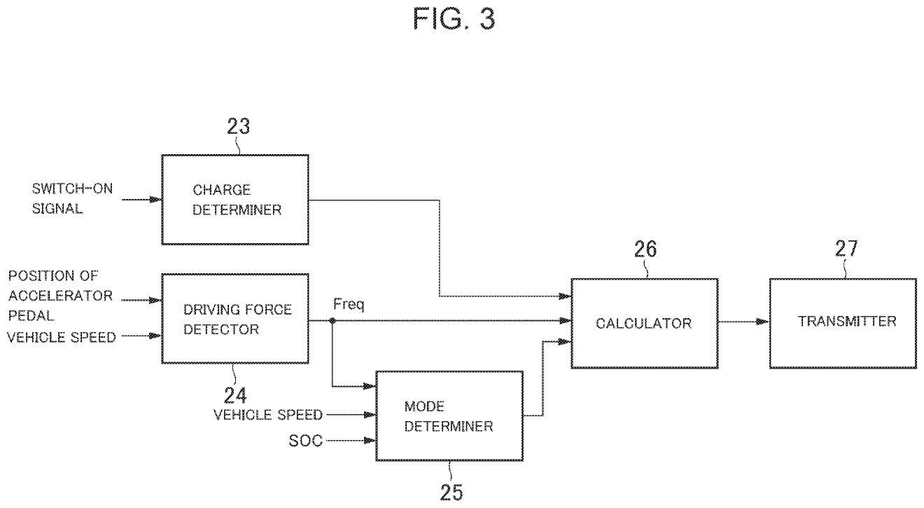

Turning to FIG. 3, there is shown one example of a structure of the ECU 21. As shown in FIG. 3, the ECU 21 comprises a charge determiner 23, a driving force detector 24, a mode determiner 25, a calculator 26, and a transmitter 27.

Specifically, the charge determiner 23 is configured to determine whether the charging switch 22 is operated by the driver. In other words, the charge determiner 23 is configured to determine whether the rapid charging command is transmitted from the charging switch 22.

The driving force detector 24 is configured to detect an operating amount (i.e., a position) of the accelerator pedal and a speed of the vehicle Ve, and to calculate a required driving force F_{req} to propel the vehicle Ve.

The mode determiner 25 is configured to determine an operating mode of the vehicle Ve from the parallel mode, the series mode, and the EV mode, depending on a required driving force F_{req}, a speed of the vehicle Ve, and an SOC level of the electric storage device 9.

The calculator 26 is configured to calculate a driving force to propel the vehicle Ve and a power generation amount of the rear motor 2 by procedures of the after-explained flowcharts.

The transmitter 27 is configured to transmit command signals based on calculation results transmitted from the calculator 26. For example, the transmitter 27 transmits command signals to the engine 1, the rear motor 2, and the front motor 4 to generate torques in required amounts, to the rear transmission 12 and the front transmission 18 to establish required gear stages, and to the clutch device 11 to engage or disengage the clutch device 11 as required.

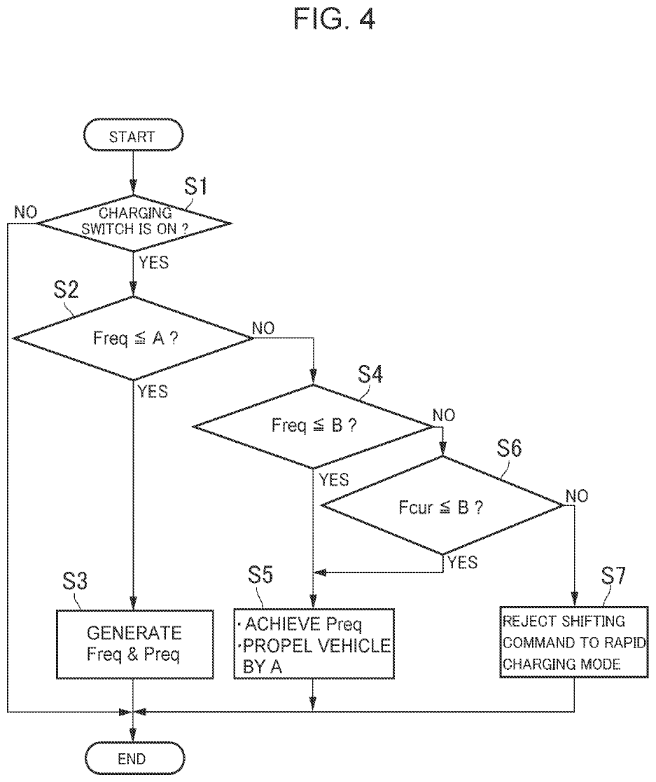

Turning to FIG. 4, there is shown one example of the procedures of the calculation performed by the calculator 26 during propulsion in the parallel mode selected by the mode determiner 25.

At step S1, it is determined whether the charging switch 22 is turned on based on the rapid charging command transmitted from the charge determiner 23 to the calculator 26.

If the charging switch 22 has not yet been turned on so that the answer of step S1 is NO, the routine returns without executing any specific control. By contrast, if the charging switch 22 is turned on so that the answer of step S1 is YES, the routine progresses to step S2 to determine whether a required driving force F_{req} is equal to or less than a first driving force A shown in FIG. 2. Specifically, the first driving force A is a maximum driving force to propel the vehicle Ve in a condition where the engine 1 generates a maximum torque while the rear motor 2 translates a power generated by the engine 1 into an electric power in the maximum amount. Accordingly, the first driving force A is less than the above-mentioned second driving force B. That is, a difference between the first driving force A and the second driving force B corresponds to a driving force to be reduced by generating a regenerative torque by the rear motor 2 to generate an electric power required as a result of turning on the charging switch 22 (to be referred to as the “required power generation amount P_{req}”).

If the required driving force F_{req} is equal to or less than the first driving force A so that the answer of step S2 is YES, the routine progresses to step S3 to control torques of the engine 1 and the rear motor 2 in such a manner as to achieve both of the required driving force F_{req} and the required power generation amount P_{req}. At step S3, specifically, the regenerative torque to be generated by the rear motor 2 to achieve the required power generation amount P_{req} is calculated by dividing the required power generation amount P_{req} by a speed of the rear motor 2, and the torque to be generated by the engine 1 is calculated by adding an absolute value of the regenerative torque of the rear motor 2 to a torque of the engine 1 calculated based on the required driving force F_{req}. Thereafter, the torques of the engine 1 and the rear motor 2 are controlled based on the calculation results, and the routine returns. In this situation, if a depression of the accelerator pedal is less than a predetermined degree θ1 to brake the vehicle Ve, and a braking force to be established by generating the regenerative torque by the rear motor 2 to achieve the required power generation amount P_{req} is less than a required braking force, the engine 1 will generate a drive torque.

If the required driving force F_{req} is greater than the first driving force A, the answer of step S2 will be NO. In this case, if the rear motor 2 is controlled in such a manner as to achieve the required power generation amount P_{req}, the required driving force F_{req} may not be achieved by mealy generating the maximum drive torque by the engine 1. In order to avoid such disadvantage, in the case that the required driving force F_{req} is greater than the first driving force A, the ECU 21 determines whether to achieve the required power generation amount P_{req} preferentially over the required driving force F_{req}, and allows the establishment of the rapid charging mode on the basis of a determination result.

Specifically, if a difference between driving forces to be generated under the current conditions in the rapid charging mode and in the normal charging mode is less than a predetermined value, the required power generation amount P_{req} will be achieved on a preferential basis. As described, the first driving force A is the maximum driving force by generating the maximum torque of the engine 1 while translating the power of the engine 1 partially into an electric power by the rear motor 2 to achieve the required power generation amount P_{req}. That is, the difference between the driving forces to be generated under the current conditions in the rapid charging mode and in the normal charging mode increases with an increase in the required driving force F_{req} from the first driving force A.

Therefore, if the required driving force F_{req} is greater than the first driving force A so that the answer of step S2 is NO, the routine progresses to step S4 to determine whether the required driving force F_{req} is equal to or less than the second driving force B. Instead, a threshold to determine whether to achieve the required power generation amount P_{req} preferentially over the required driving force F_{req} may also be set to a greater value than the second driving force B.

If the required driving force F_{req} is equal to or less than the second driving force B so that the answer of step S4 is YES, the routine progresses to step S5 to generate the regenerative torque of the rear motor 2 while generating the maximum torque of the engine 1 so as to achieve the required power generation amount P_{req}. At step S5, specifically, the driving force to propel the vehicle Ve is restricted to the first driving force A, and the required power generation amount P_{req} is achieved by generating electric power by the rear motor 2. In other words, the charging mode is allowed to shift from the normal charging mode to the rapid charging mode, and the required power generation amount P_{req} is achieved on a preferential basis while restricting the driving force to propel the vehicle Ve less than the required driving force.

By contrast, if the required driving force F_{req} is greater than the second driving force B so that the answer of step S4 is NO, the routine progresses to step S6 to determine whether a current available driving force F_{cur} to propel the vehicle Ve is equal to or less than the second driving force B. For example, the drive torque possible to be generated by the rear motor 2 would be restricted given that an SOC level of the electric storage device 9 is equal to or lower than a predetermined level, or that a speed of the vehicle Ve is equal to or higher than a predetermined level. In those cases, the driving force may not be increased from the second driving force B. As a result, the difference between: the driving force to be generated under the current conditions in the rapid charging mode (i.e., the first driving force A); and the driving force to be generated under the current conditions in the normal charging mode (i.e., the current available driving force F_{cur}), will be reduced smaller than a predetermined value. In some embodiments, in this case, the rapid charging mode is selected.

If the current available driving force F_{cur} is equal to or less than the second driving force B so that the answer of step S6 is YES, the routine also progresses to step S5. By contrast, if the current available driving force F_{cur} is greater than the second driving force B so that the answer of step S6 is NO, the routine progresses to step S7 to reject the rapid charging command to shift the charging mode to the rapid charging mode which has been transmitted as a result of turning on the charging switch 22, and thereafter returns. In this case, the difference between the driving force to be generated under the current conditions in the rapid charging mode (i.e., the first driving force A) and the current available driving force F_{cur} will be increased greater than the predetermined value. Therefore, if the rapid charging mode is selected in this case, the driving force would be reduced to the first driving force A, and then, if the charging switch 22 is turned off, the driving force would be increased abruptly to the current available driving force F_{cur}. In order to avoid such disadvantage, at step S7, the establishment of the rapid charging mode is inhibited, and the required driving force F_{req} is generated on a priority basis. As an option, at step S7, the driver may be notified of the rejection of the establishment the rapid charging mode by e.g., a warning tone or an indicator.

Thus, in the case that the required driving force F_{req} is greater than the first driving force A but equal to or less than the second driving force B, the vehicle Ve is propelled by the first driving force A while achieving the required power generation amount P_{req}. According to the exemplary embodiment of the present disclosure, therefore, the required power generation amount P_{req} may be achieved without changing the driving force significantly from the required driving force F_{req}. In other words, the driving force will not be reduced significantly even if the charging switch 22 is turned on. In addition, in the case that the required driving force F_{req} is greater than the second driving force B, the rapid charging command to shift the charging mode to the rapid charging mode will be rejected. In this case, therefore, the driving force will also not be reduced significantly even if the charging switch 22 is turned on.

In some embodiments, if the required driving force F_{req} increases in the rapid charging mode, the required driving force F_{req} is achieved preferentially over the required power generation amount P_{req}. To this end, the ECU 21 is further configured to cancel the rapid charging mode in accordance with a change in the required driving force F_{req}, and to shift the charging mode to the normal charging mode so as to generate the required driving force F_{req}.

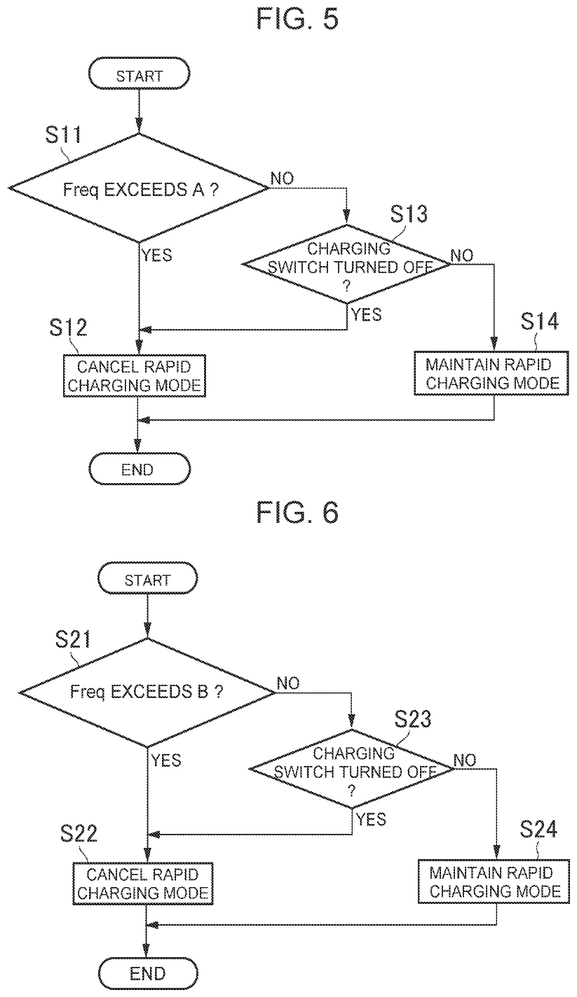

Turning to FIG. 5, there is shown an example of a routine to be executed when the required driving force F_{req} is equal to or less than the first driving force A during propulsion in the rapid charging mode. At step S11, it is determined whether the required driving force F_{req} is increased greater than the first driving force A based on e.g., a position of the accelerator pedal detected by the accelerator sensor.

During execution of the routine shown in FIG. 4, when the charging switch 22 is turned on under the condition in which the required driving force F_{req} is greater than the first driving force A but smaller than the second driving force B, the diving force to propel the vehicle Ve is restricted to the first driving force A. However, if the required driving force F_{req} is increased across the first driving force A during propulsion in the rapid charging mode while fulfilling the required power generation amount P_{req}, the driver may sense a lack of driving force. In order to prevent the driver from sensing a lack of driving force, if the required driving force F_{req} exceeds the first driving force A so that the answer of step S11 is YES, the routine progresses to step S12 to cancel the rapid charging mode, and thereafter returns. Consequently, the charging mode is shifted to the normal charging mode, and the driving force is generated in line with the required driving force F_{req}. In this situation, the engine 1 is allowed to generate the maximum torque, and the rear motor 2 is allowed to serve as a generator as long as the required driving force F_{req} is achieved. That is, in the case that the answer of step S11 is YES, a generation amount of the rear motor 2 may be restricted less than the required power generation amount P_{req}. As an option, at step S12, the driver may be notified of the cancellation of the rapid charging mode by e.g., a warning tone or an indicator.

By contrast, if the required driving force F_{req} is less than the first driving force A so that the answer of step S11 is NO, the routine progresses to step S13 to determine whether the charging switch 22 is turned off based on a command signal transmitted from the charging switch 22 to the ECU 21.

If the charging switch 22 has been turned off so that the answer of step S13 is YES, the routine also progresses to step S12 to cancel the rapid charging mode, and thereafter returns. By contrast, if the charging switch 22 has not yet been turned off so that the answer of step S13 is NO, the routine progresses to step S14 to maintain the rapid charging mode. In this case, it is possible to generate the driving force in line with the required driving force F_{req} while generating the electric power in line with the required power generation amount P_{req}. In this case, therefore, torques of the engine 1 and the rear motor 2 are controlled in such a manner as to achieve both of the required driving force F_{req} and the required power generation amount P_{req}. Thereafter, the routine returns.

Turning to FIG. 6, there is shown an example of a routine to be executed when the required driving force F_{req} is greater than the first driving force A but equal to or less than the second driving force B during propulsion in the rapid charging mode. At step S21, it is determined whether the required driving force F_{req} is increased greater than the second driving force B based on e.g., a position of the accelerator pedal detected by the accelerator sensor.

If the required driving force F_{req} exceeds the second driving force B so that the answer of step S21 is YES, the routine progresses to step S22 to cancel the rapid charging mode. Consequently, the charging mode is shifted to the normal charging mode, and the driving force is generated in line with the required driving force F_{req}. Thereafter, the routine returns. At step S22, the driver may also be notified of the cancellation of the rapid charging mode by e.g., a warning tone or an indicator.

By contrast, if the required driving force F_{req} is less than the second driving force B so that the answer of step S21 is NO, the routine progresses to step S23 to determine whether the charging switch 22 is turned off based on a command signal transmitted from the charging switch 22 to the ECU 21.

If the charging switch 22 has been turned off so that the answer of step S23 is YES, the routine also progresses to step S22 to cancel the rapid charging mode, and thereafter returns. By contrast, if the charging switch 22 has not yet been turned off so that the answer of step S23 is NO, the routine progresses to step S24 to maintain the rapid charging mode. In this case, specifically, torques of the engine 1 and the rear motor 2 are controlled in such a manner as to propel the vehicle Ve by the first driving force A while fulfilling the required power generation amount P_{req}. Thereafter, the routine returns.

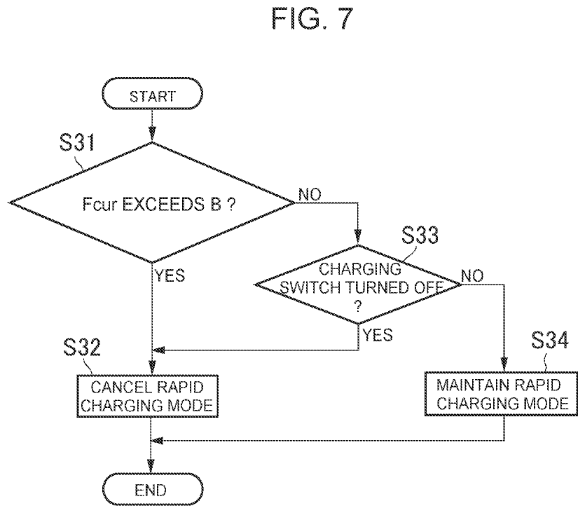

Turning to FIG. 7, there is shown an example of a routine to be executed when the required driving force F_{req} is greater than the second driving force B but the current available driving force F_{cur} is equal to or less than the second driving force B during propulsion in the rapid charging mode. At step S31, it is determined whether the current available driving force F_{cur} is increased greater than the second driving force B. For example, such determination at step S31 may be made based on a fact that an SOC level of the electric storage device 9 is raised to a predetermined level or higher, or that a speed of the vehicle Ve is reduced lower than a predetermined level.

If the current available driving force F_{cur} exceeds the second driving force B so that the answer of step S31 is YES, the routine progresses to step S32 to cancel the rapid charging mode. Consequently, the charging mode is shifted to the normal charging mode, and the driving force is generated in line with the required driving force F_{req}. Thereafter, the routine returns. At step S32, the driver may also be notified of the cancellation of the rapid charging mode by e.g., a warning tone or an indicator.

By contrast, if the current available driving force F_{cur} is less than the second driving force B so that the answer of step S31 is NO, the routine progresses to step S33 to determine whether the charging switch 22 is turned off based on a command signal transmitted from the charging switch 22 to the ECU 21.

If the charging switch 22 has been turned off so that the answer of step S33 is YES, the routine also progresses to step S32 to cancel the rapid charging mode, and thereafter returns. By contrast, if the charging switch 22 has not yet been turned off so that the answer of step S33 is NO, the routine progresses to step S34 to maintain the rapid charging mode. In this case, specifically, torques of the engine 1 and the rear motor 2 are controlled in such a manner as to propel the vehicle Ve by the first driving force A while fulfilling the required power generation amount P_{req}. Thereafter, the routine returns.

In the case that the required driving force F_{req} is increased during propulsion in the rapid charging mode, a driving force to achieve the increased required driving force F_{req} may not be generated while fulfilling the required power generation amount P_{req} by the rear motor 2. In this case, therefore, the required driving force F_{req} will be achieved on a preferential basis. According to the exemplary embodiment of the present disclosure, therefore, the driving force may be increased in line with the driver's attention to prevent a lack of driving force.

The foregoing routines shown in FIGS. 4 to 7 may be executed not only separately but also integrally.

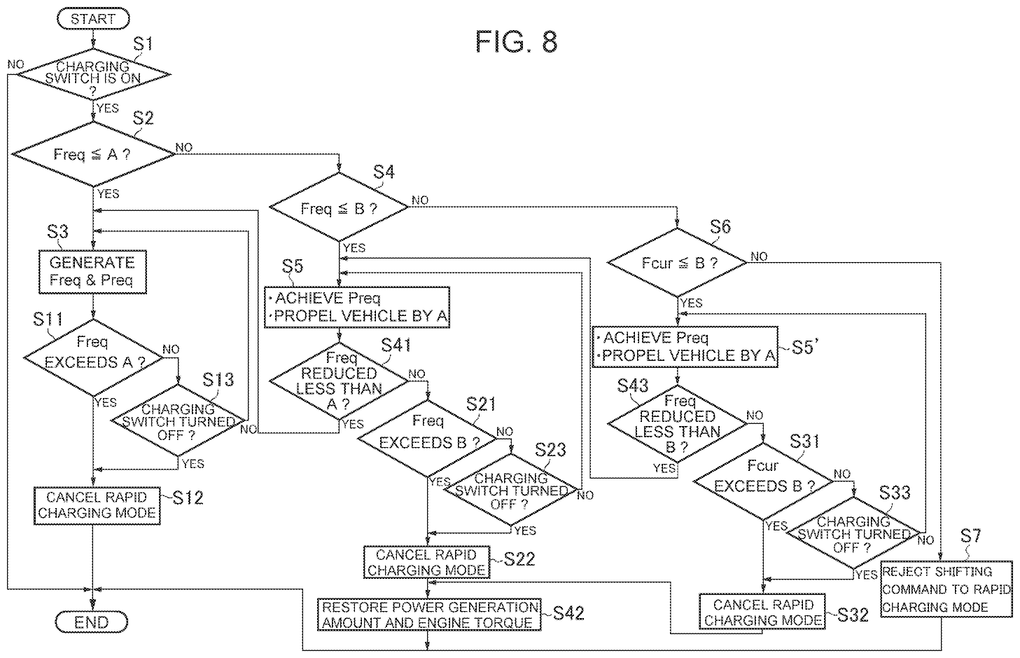

Turning to FIG. 8, there is shown an example of a routine of executing the routines shown in FIGS. 4 to 7 integrally, and detailed explanations for the steps in common with those of the routines shown in FIGS. 4 to 7 will be omitted.

According to the example shown in FIG. 8, after controlling torques of the engine 1 and the rear motor 2 to achieve both of the required driving force F_{req} and the required power generation amount P_{req} at step S3, the routine progresses to step S11. That is, in the case that the required driving force F_{req} is equal to or less than the first driving force A, the charging mode is shifted to the rapid charging mode, and the required driving force F_{req} and the required power generation amount P_{req} will be fulfilled until the charging switch 22 will be turned off. In this situation, when the required driving force F_{req} exceeds the first driving force A, or when the charging switch 22 is turned off, the rapid charging mode is cancelled to control the torques of the engine 1 and the rear motor 2 in the normal charging mode.

In the case that the required driving force F_{req} is equal to or less than the second driving force B so that the answer of step S4 is YES, the routine also progresses to step S5 to achieve the required power generation amount P_{req} by the rear motor 2 while restricting the driving force to propel the vehicle Ve to the first driving force A in the rapid charging mode. Then, the routine progresses to step S41 to determine whether the required driving force F_{req} is reduced to the first driving force A or smaller. In this case, if the required driving force F_{req} is reduced to the first driving force A or less, both of the required driving force F_{req} and the required power generation amount P_{req} may be achieved. Therefore, if the required driving force F_{req} is reduced to the first driving force A or smaller so that the answer of step S41 is YES, the restriction of the driving force is cancelled and the routine progresses to step S3. By contrast, if the required driving force F_{req} is greater than the first driving force A so that the answer of step S41 is NO, the routine progresses to step S21.

In the case that the required driving force F_{req} exceeds the second driving force B so that the answer of step S21 is YES, the routine also progresses to step S22 to cancel the rapid charging mode. In this case, it is necessary to increase the driving force from the first driving force A. To this end, the routine further progresses to step S42 to change a power generation amount by the rear motor 2 and a torque of the engine 1 gradually to normal values in the normal charging mode. At step S42, specifically, the torques of the rear motor 2 and the engine 1 are increased gradually to increase the driving force at a predetermined change rate which is set such that the driver will not feel uncomfortable feeling. Thereafter, the routine returns.

In the case that the current available driving force Four is equal to or less than the second driving force B so that the answer of step S6 is YES, the routine progresses to step S5′ to achieve the required power generation amount P_{req} by the rear motor 2 while restricting the driving force to propel the vehicle Ve to the first driving force A in the rapid charging mode. Then, the routine further progresses to step S43 to determine whether the required driving force F_{req} is reduced to the second driving force B or smaller. If the required driving force F_{req} is reduced to the second driving force B or smaller so that the answer of step S43 is YES, the routine progresses to step S5, and the rapid charging mode will be cancelled at step S22 upon satisfaction of the condition at step S21 or S23. By contrast, if the required driving force F_{req} is greater than the second driving force B so that the answer of step S43 is NO, the routine progresses to step S31. In this case, the rapid charging mode will be cancelled at step S32 upon satisfaction of the condition at step S31 or S33. Then, the routine progresses to step S42 to change a power generation amount by the rear motor 2 and a torque of the engine 1 gradually to normal values in the normal charging mode. Thereafter, the routine returns.

Although the above exemplary embodiment of the present disclosure has been described, it will be understood by those skilled in the art that the present disclosure should not be limited to the described exemplary embodiments, and various changes and modifications can be made within the scope of the present disclosure. For example, the front drive unit 5 may be omitted. In addition, the rear motor 2 may be disposed downstream of the rear transmission 12, or an additional motor serving as a generator may be arranged downstream of the rear transmission 12.

What is claimed is:

1. A control system for a hybrid vehicle comprising:
an engine; and
a motor that translates a power delivered thereto from the engine partially into an electric power by generating a regenerative torque, and that applies a drive torque to a pair of drive wheels,
wherein the hybrid vehicle may be propelled in a parallel mode in which the power generated by the engine is partially translated into the electric power by the motor and a remaining power generated by the engine is delivered to the drive wheels, or the power generated by the engine and a power generated by the motor are delivered to the drive wheels,
a driver is allowed to manually transmit a charging command to increase a power generation amount of the motor to a predetermined generation amount during propulsion in the parallel mode,
the control system comprising:
a controller that controls torques of the engine and the motor,
wherein the controller comprises a charge determiner that determines a transmission of the charging command, and a driving force detector that calculates a required driving force to propel the hybrid vehicle, and
the controller is configured to operate the motor to generate the electric power in the predetermined generation amount while restricting a driving force to a first driving force, in a case that the charge determiner determines the transmission of the charging command and that the required driving force calculated by the driving force detector is greater than the first driving force.

2. The control system for the hybrid vehicle as claimed in claim 1, wherein the controller is further configured to operate the motor to generate the electric power in the predetermined generation amount while generating the driving force in line with the required driving force, in a case that the charge determiner determines the transmission of the charging command and that the required driving force calculated by the driving force detector is equal to or less than the first driving force.

3. The control system for the hybrid vehicle as claimed in claim 1, wherein the controller is further configured to restrict the power generation amount of the motor to the predetermined generation amount or less while generating the driving force in line with the required driving force, in a case that the charge determiner determines the transmission of the charging command, that the required driving force calculated by the driving force detector is equal to or less than the first driving force, and that the required driving force is increased greater than the first driving force.

4. The control system for the hybrid vehicle as claimed in claim 1, wherein the first driving force is set to a value to be achieved by generating a maximum torque of the engine while generating the electric power in the predetermined generation amount.

5. The control system for the hybrid vehicle as claimed in claim 1, wherein the controller is further configured to restrict the power generation amount of the motor to the predetermined generation amount or less while generating the driving force in line with the required driving force, in a case that the charge determiner determines the transmission of the charging command, and that the required driving force calculated by the driving force detector is greater than a second driving force that is greater than the first driving force.

6. The control system for the hybrid vehicle as claimed in claim 5, wherein the second driving force is set to a value to be achieved by generating a maximum torque of the engine while stopping the motor.

7. The control system for the hybrid vehicle as claimed in claim 5, wherein the controller is further configured to operate the motor to generate the electric power in the predetermined generation amount while restricting the driving force to the first driving force, in a case that the charge determiner determines the transmission of the charging command, that the required driving force calculated by the driving force detector is greater than the second driving force, and that a current available driving force to propel the hybrid vehicle is restricted to the second driving force.

8. The control system for the hybrid vehicle as claimed in claim 7, further comprising:
an electric storage device that is electrically connected with the motor,
wherein the controller is further configured to restrict the current available driving force to propel the hybrid vehicle to the second driving force in a case that a state of charge level of the electric storage device is equal to or lower than a predetermined level, or that a speed of the hybrid vehicle is equal to or higher than a predetermined level.
